(19) United States
(12) Patent Application Publication
(10) Pub. No.: US 2022/0049763 A1
(43) Pub. Date: Feb. 17, 2022

(54) PULLEY ASSEMBLY

(71) Applicant: DEERE & COMPANY, MOLINE, IL (US)

(72) Inventor: Joel P. Anderson, BETTENDORF, IA (US)

(21) Appl. No.: 16/990,312

(22) Filed: Aug. 11, 2020

(51) Int. Cl. F16H 55/49; F16H 55/52; F16H 55/38

(52) U.S. Cl. CPC F16H 55/49; F16H 55/38; F16H 55/52

(57) ABSTRACT

Pulley assemblies and associated methods are disclosed. An example pulley assembly may include a first pulley and a second pulley laterally movable relative to the first pulley. The first pulley and the second pulley provide for different drive ratios. The second pulley is movable from a first position in which the second pulley is laterally offset from the first pulley and a second position in which the second pulley is laterally aligned with the first pulley. An endless drive components, such as an endless belt, maintains a constant position whether the endless drive component is engaged with the first pulley or the second pulley located in the second position.

### FIELD OF THE DISCLOSURE

The present disclosure relates generally to pulleys, such as pulleys for a belt drive.

### BACKGROUND OF THE DISCLOSURE

A belt drive generally involves two or more pulleys rotatably coupled via an endless belt that engages the one or more pulleys. The flexible belt transmits rotation from one pulley to another.

### SUMMARY OF THE DISCLOSURE

A first aspect of the present disclosure is directed to a pulley assembly. The pulley assembly may include a first pulley and a second pulley. The second pulley is slidable relative to the first pulley between a first position in which the second pulley is laterally offset from the first pulley and a second deposition in which the second pulley is laterally aligned with the first pulley.

A second aspect of the present disclosure is directed to a drive system. The drive system may include a pulley assembly that includes a first pulley and a second pulley, a third pulley offset from the pulley assembly, and an endless drive component engaged with the pulley assembly and the third pulley such that rotation of the pulley assembly or the third pulley is transmitted to the other of the pulley assembly and the third pulley via the endless drive component. The first pulley may include a first axis of rotation; the second pulley may include a second axis of rotation that is aligned with the first axis of rotation; and the second pulley may be slidable relative to the first pulley between a first position in which the second pulley is laterally offset from the first pulley and a second deposition in which the second pulley is laterally aligned with the first pulley.

The various aspects may include one or more of the following features. The second pulley may define a cavity, and the first pulley may be disposed in the cavity when the second pulley is in the second position. The first pulley may include a first axis of rotation; the second pulley may include a second axis of rotation; and the first axis of rotation may align with the second axis of rotation. Lateral alignment of the first pulley and the second pulley when the second pulley is in the second position may include alignment of a center of a width of the first pulley with a center of a width of the second pulley. The first pulley may also include an axially extending collar, and the second pulley is may be slideable along the axially extending collar. The first pulley and the second pulley may be rotatably coupled such that the first pulley and the second pulley rotate together. The first pulley and the second pulley may be coupled with one of a splined connection or a keyed connection that provides for relative axial sliding movement between the first pulley and the second pulley while simultaneous providing for concurrent rotation of the first pulley and the second pulley. The first pulley may define a first drive component engaging surface configured to engage an endless component, and the second pulley may define a second drive component engaging surface configured to engage the endless component. The first drive component engaging surface and the second drive component engaging surface may be configured to engage an endless belt or an endless chain. The first drive component engaging surface and the second drive component engaging surface may be configured to conform to a V-belt. The first drive component engaging surface and the second drive component engaging surface may define a plurality of grooves. A locking arrangement may couple the first pulley to the second pulley so that the first pulley and the second pulley rotate together while preventing axial movement of the first pulley relative to the second pulley. The locking arrangement may include a pin removably received into aligned apertures formed in the first pulley and the second pulley to releasably coupled the first pulley and the second pulley together. The first pulley may align with the third pulley, and the second pulley may align with the third pulley when the second pulley is in the second position.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a cross-sectional view of an example pulley assembly, according to some implementations of the present disclosure

FIG. 2 is a cross-sectional view of the pulley assembly of FIG. 1 in which a second pulley is laterally moved into a second position that aligns with a first pulley, according to some implementations of the present disclosure.

FIG. 3 is a flowchart of an example method of repositioning a drive component from a first pulley to a second pulley of a pulley assembly, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to pulley assemblies that provides for a change in a drive ratio without the use of, for example, a gearbox or torque sensing variable diameter sheaves. Further, the pulley assemblies within the scope of the present disclosure provide for a belt drive that avoids multiple belt positions. The belt maintains a constant position notwithstanding a configuration of the pulley assembly. Consequently, a space occupied by the belt drive is reduced, thereby reducing packaging associated with the belt drive. Although the example implementations described herein are made in the context of an endless belt drive, the scope of the present disclosure encompasses other types of endless components, such as chains, and the pulleys described are configured to engage the respective endless components. For example, for a chain, the pulley may include teeth that engage with the chain. Further, although V-belts are described, other types of belts, such as flat belts or cog belts, are also within the scope of the present disclosure.

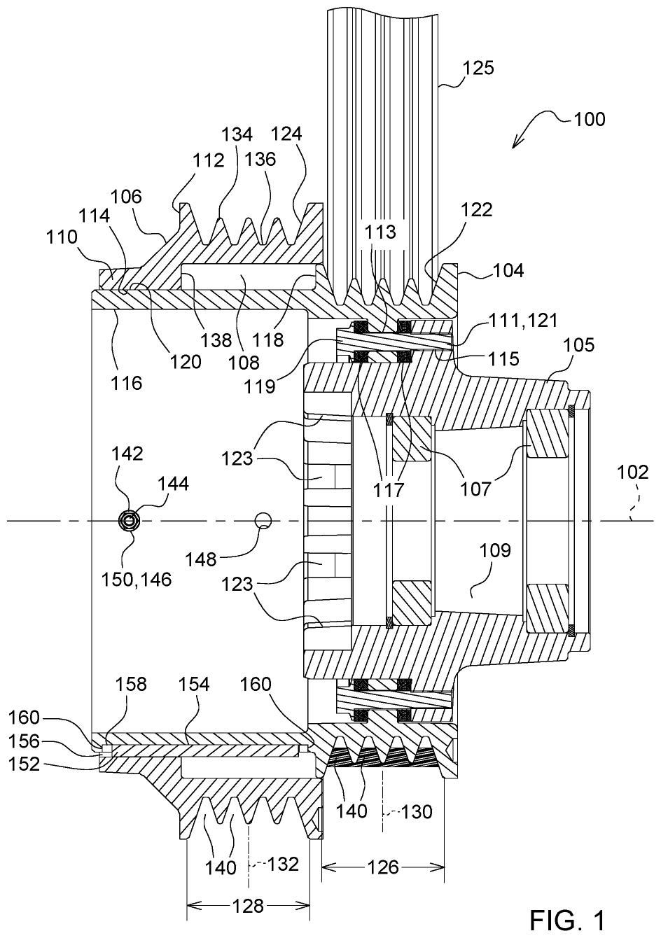

FIG. 1 is a cross sectional view of an example pulley assembly 100 taken about a plane that passes through a central axis 102 of the pulley assembly 100. The pulley assembly 100 includes a first pulley 104 and a second pulley 106. The central axis 102 defines a common axis of rotation of both the first pulley 104 and the second pulley 106. The first pulley 104 may be coupled to a driven shaft, such as a shaft driven by an engine, an electric motor, or other type of apparatus operable to generate rotational motion. The driven shaft couples to a hub 105 of the pulley assembly 100.

In the illustrated example, the pulley assembly 100 includes bearings 107 that are received into a bore 109 formed by the hub 105. The bearings 107 engage the driven shaft. The bearings 107 provide for rotation of the drive shaft relative to the hub 105. In some implementations, the bearings 107 may be roller bearings, for example. The drive shaft may also include interlocking features that intermesh with slots 123 radially arranged about the bore 109. The interlocking features of the drive shaft may releasably engage with the slots 123 to fix the drive shaft and the hub 105 together such that the drive shaft and the hub 105 rotate together. With the drive shaft disengaged from the hub, 105, the hub 105 rotates relative to the drive shaft via the bearings 107. In other implementations, the interlocking features and bearings may be omitted. Thus, in some implementations, the hub 105 may be fixedly secured to the drive shaft such that the drive shaft and the hub 105 rotate together.

The first pulley 104 is secured to the hub 105 via fasteners 111. The fasteners 111 are receive into aligned apertures 113 and 115 formed in the first pulley 104 and hub 105, respectively. In some implementations, spacers 117 may be sandwiched between an end 119 of the fasteners 111 and the first pulley 104 and the first pulley 104 and the hub 105. The apertures 115 may be threaded to engage with mating threads formed on the end 121 of the fasteners 111. In other implementations, the first pulley 104 may be secured to the hub in other ways, such as a friction fit, an adhesive, or welding. The second pulley 106 is coupled to the first pulley 104 as described below. In some implementations, the first pulley 104 and the hub 105 may have a position fixed relative to the driven shaft.

The second pulley 106 defines a cavity 108 and includes a collar 110 that extends from a first side 112 of the second pulley 106. The collar 110 includes an interior surface 114. The first pulley 104 includes a collar 116 extending axially from a first side 118 of the first pulley 104. The collar 116 includes an exterior surface 120. The second pulley 106 is movable relative to the first pulley 104. Particularly, the second pulley 106 is slideable over the collar 116 of the first pulley such that the interior surface 114 of the second pulley 106 slides over the exterior surface 120 of the first pulley 104.

The first pulley 104 further includes a drive component engaging surface 122, and the second pulley 106 includes a drive component engaging surface 124. In some implementations, a width 126 of the drive component engaging surface 122 is equal to a width 128 of the drive component engaging surface 124. In other implementations, the widths 126 and 128 may be unequal. The width 126 of the first pulley 104 includes a center 130, and the width 128 of the second pulley 106 includes a center 132. The drive component engaging surfaces 122 and 124 engage a drive component, which may be an endless belt, chain, or other continuous component that operates to transfer motion, such as rotary motion from the pulley assembly 100 to one or more other pulleys.

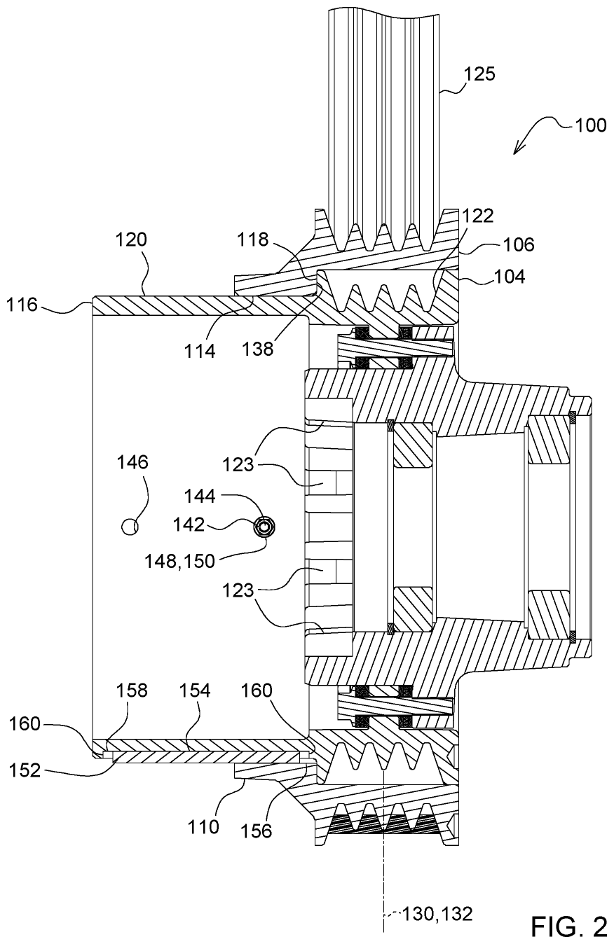

In the illustrated example, the drive component engaging surfaces 122 and 124 include a profile having a plurality of grooves 140 that define a plurality of peaks 134 and valleys 136 and are, consequently, configured to engaged with a V-belt. A cross-sectional profile of a V-belt, such as V-belt 125 shown in FIGS. 1 and 2, conforms to the profile of the drive component engaging surfaces 122 and 124 in the illustrated example. However, in other implementations, the drive component engaging surfaces 122 and 124 may have other profiles that conform to cross-sectional profiles of other types of drive components.

The second pulley 106 is moveable between a first position shown in FIG. 1 and a second position shown in FIG. 2 in which the center 130 of the width 126 of the first pulley 104 aligns with the center 132 of the width 128 of the second pulley 106. Because the second pulley 106 has a larger diameter than the first pulley 104, movement of the second pulley 106 into the second position alters a drive ratio provided by the pulley assembly 100.

Referring to FIG. 2, the second pulley 106 is moved into the second position by laterally sliding the second pulley 106 over the exterior surface 120 of the first pulley 104. As the second pulley 106 is moved into the second position, the first pulley 104 is received into the cavity 108. In the illustrated example, the second pulley 106 is located in the second position when a shoulder 138 of the second pulley 106 is in abutting contact with the first side 118 of the first pulley 104. As indicated earlier, with the second pulley 106 located in the second position, the center 132 of the width 128 of the second pulley 106 aligns with the center 130 of the width 126 of the first pulley 104.

The second pulley 106 may be secured in the first position, the second position, or both in any number of ways. For example, in some implementations, the pulley system 100 may include a locking arrangement 142. In the illustrated example, the locking arrangement 142 includes a pin 144 that is receivable into aligned apertures formed in the first and second pulleys 104 and 106. As shown in FIGS. 1 and 2, the first pulley 104 includes a first aperture 146 and a second aperture 148 formed in the collar 116. The second pulley 106 includes an aperture 150 formed in the collar 110. The aperture 150 of the second pulley 106 aligns with the first aperture 146 when the second pulley 106 is in the first position, and the aperture 150 of the second pulley 106 aligns with the second aperture 148 of the first pulley 104 when the second pulley 106 is in the second position. Although the illustrated example shows a single aperture formed in the first pulley 104 corresponding to each of the first position and second position (i.e., apertures 146 and 148, respectively) and a single aperture (i.e., aperture 150) formed in the second pulley 106, in other implementations, the second pulley 106 may include a plurality of apertures configured to align with a corresponding plurality of apertures formed in the first pulley 104 provided at locations corresponding to each of the first and second positions. Further, in other implementations, a plurality of pins may be utilized to be received into the aligned apertures of the first and second pulleys 104 and 106. In some implementations, the pin 144 may be a bolt, another type of fastener, or other component that is removably receivable into the aligned apertures, e.g., aligned apertures 146 and 150 or apertures 148 and 150.

In the first position, the second pulley 106 is laterally offset from the first pulley 104 such that the center 132 does not align with the center 130, and the first aperture 146 of the first pulley 104 aligns with the aperture 150 of the second pulley 106. The pin 144 of the locking arrangement 142 is received into the aligned apertures 146 and 150 to fix the first and second pulleys 104 and 106 together with the second pulley 106 located in the first position. With the first and second pulleys 104 and 106 are fixed together via the locking arrangement 142, the first and second pulleys 104 and 106 are prevented from moving relative to each other. Thus, with the first and second pulleys 104 and 106 fixed together, the first and second pulleys 104 and 106 rotate together in response to movement of a drive component, e.g., an endless belt, such as a V-belt, or other component, that is engaged with the drive component engaging surface 122 of the first pulley 104.

In the second position, the center 132 of the width 128 of the second pulley 106 aligns with the center 130 of the width 126 of the first pulley 104, and the second aperture 148 of the first pulley 104 aligns with the aperture 150 of the second pulley 106. Further, as explained earlier, in the second position, the first pulley 104 is received into the cavity 108 defined by the second pulley 106. The pin 144 is received into the aligned apertures 148 and 150 to fix the first and second pulleys 104 and 106 together with the second pulley 106 located in the second position. Securing the first and second pulleys 104 and 106 together in this way results in the first and second pulleys 104 and 106 being rotated together in response to movement of a drive component, e.g., an endless belt, such as a V-belt, or other component, that is engaged with the drive component engaging surface 124 of the second pulley 106.

The locking arrangement 142 may include other types of interlocking features. For example, the locking arrangement 142 may include other features that provide for selectively locking the first pulley 104 and the second pulley 106 together, resulting in the prevention of relative rotation of the first pulley 104 and the second pulley 106 or relative lateral movement of the first pulley 104 and the second pulley 106 or both.

With the second pulley 106 in the first position, the pulley assembly 100 provides a first gear ratio, and, with the second pulley 106 in the second position, the pulley assembly 100 provides a second drive ratio different from the first gear ratio. The ratios provided may vary depending on the size, i.e., the effective diameter, of the pulleys 104 and 106. Thus, the sizes of the pulleys 104 and 106 may be selected to be any size such that the first pulley 104 is able to reside inside of the cavity 108 defined by the second pulley 106 when the second pulley is in the second position.

In some implementations, the first and second pulleys 104 and 106 may have a splined connection. For example, in some implementations, mating splined surfaces may be formed on surfaces 120 and 114 of the first and second pulleys 104 and 106, respectively. The mating splined surfaces allow the first and second pulleys 104 and 106 to move laterally relative to each other while angularly fixing the first and second pulleys 104 and 106 about central axis 102, thereby preventing rotation of the first pulley 104 and the second pulley 106 relative to each other. Consequently, movement of a drive component, e.g., an endless belt, whether engaged with the drive component engaging surface of the first pulley or the second pulley, causes simultaneous rotation of the first pulley 104 and the second pulley 106.

In still other implementations, the pulley assembly 100 may include a keyed connection between the first pulley 104 and the second pulley 106. For example, as shown in FIGS. 1 and 2, a key 152 may be disposed in a cavity 154 defined by aligned slots 156 and 158 formed in the first and second pulleys 104 and 106 respectively. The slot 156 extends through an entirety of the collar 110 of the second pulley 106 and, thus, omits ends surfaces. This configuration of the slot 156 provides for lateral movement of the second pulley relative to the first pulley 104. The second pulley 106 includes ends surfaces 160 at opposing ends of the slot 158. The ends surfaces 160 operate to retain the key 152 in the lateral directions even as the first and second pulleys 104 and 106 are moved laterally relative to each other, as shown in FIG. 2.

Similar to the splined connection, the keyed connection provides for relative lateral movement of the first and second pulleys 104 and 106 while angularly fixing the first and second pulleys 104 and 106. Thus, the keyed connection prevents the first pulley 104 and the second pulley 106 from rotating relative to each other. Other types of interconnecting features that provide for lateral movement of the first pulley 104 relative to the second pulley 106 so that the second pulley 106 may be positioned between the first and second positions while preventing rotation of the first pulley 104 relative to the second pulley 106 may also be used and are within the scope of the present disclosure. Further, aligning features, such as a pin and aligned apertures, as described above, or other interlocking features may be used in combination with the splined connection or keyed connection to laterally fix the first and second pulleys 104 and 106 relative to each other.

As a result of ability of the second pulley 106 to move from the first position in which the second pulley 106 is laterally offset from the first pulley 104 and the second position in which the second pulley 106 is in lateral alignment with the first pulley 104 to engage the drive component, the drive component, such as V-belt or other type of endless drive component, maintains a constant position. As a result, the space occupied by a drive system associated with the pulley assembly 100 occupies a reduced volume, which results in a reduced packaging size of the drive system.

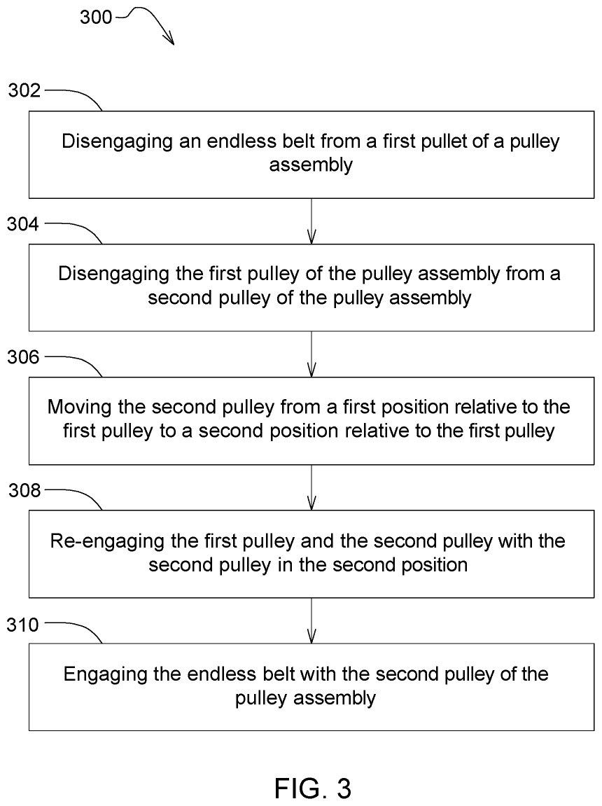

FIG. 3 is a flowchart for an example method 300 for changing a drive ratio of a pulley assembly, such as pulley assembly 100, by switching engagement of a drive component, described in this example as an endless belt, from a first pulley to a second pulley. At 302, the endless belt is disengaged from the first pulley. Disengaging the endless belt from the first pulley may include removing or reducing tension in the endless belt. For example, a tensioner may be used to form tension in the endless belt, and the tensioner may be manipulated, such as by changing a position of the tensioner relative to the endless belt, to remove or reduce the tension in the endless belt. At 304, the first pulley is disengaged from a second pulley. For example, disengaging the first pulley form the second pulley may include disengaging a locking arrangement to release the first pulley from the second pulley. Disengaging a locking assembly may include withdrawing one or more pins from aligned apertures formed in the first and second pulleys. As explained above, other types of locking arrangements may be used to release the first pulley from the second pulley. Further, disengaging the first pulley from the second pulley allows for moving the first pulley and second pulley laterally relative to each other. At 306, the second pulley is moved from a first position in which the second pulley is laterally offset from the first pulley into a second position in which the second pulley is laterally aligned with the first pulley. In some implementations, laterally aligning the second pulley with the first pulley includes laterally displacing the second pulley relative to the first pulley so that a center of a width of a drive component engaging surface of the second pulley laterally aligns with a center of a width of a drive component engaging surface of the first pulley. As a result, a position of the endless belt where the endless belt engages the second pulley in the second position is identical to the position where the endless belt engages the first pulley. Thus, the position of the endless belt, whether engaged with the first or second pulley, remains unchanged. At 308, the second pulley, in the second position, is secured to the first pulley. Securing the second pulley, in the second position, to the first pulley may include engaging the locking arrangement to secure the first pulley and the second pulley together. Engaging the locking assembly may include inserting one or more pins into aligned apertures formed in the first and second pulleys. At 310, the endless belt is engaged with the second pulley. Engaging the endless belt with the second pulley may include engaging the endless belt with the drive component engaging surface of the second belt. Engaging the endless belt with the drive component engaging surface also may include reapplying tension to the endless belt, such as by repositioning a tensioner relative to the endless belt. Repositioning the endless belt from the second pulley to the first pulley may be performed by reversing the described operations.

The example method 300 may include additional, fewer, different, or differently ordered features. For example, in some implementations, the method 300 may include ceasing operation of the pulley assembly prior to or as part of disengaging the endless belt from the first pulley; reinstating operation of the pulley assembly, e.g., initiating rotation of the pulley assembly, as part of engaging the endless belt with the second pulley; or both.

Without in any way limiting the scope, interpretation, or application of the claims appearing below, a technical effect of one or more of the example implementations disclosed herein is providing a pulley assembly that results in a reduced volume occupied by an associated drive system as a result of the endless drive component, e.g., drive belt, occupying a constant position irrespective of the pulley of the pulley system with which the endless drive component is engaged. As a consequence, the pulley assemblies within the scope of the present disclosure provide for machines incorporating such pulley assemblies having a reduced size and, consequently, a reduced weight.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A pulley assembly comprising:
a first pulley; and
a second pulley that is slidable relative to the first pulley between a first position in which the second pulley is laterally offset from the first pulley and a second deposition in which the second pulley is laterally aligned with the first pulley.

2. The pulley assembly of claim 1, wherein the second pulley defines a cavity and wherein the first pulley is disposed in the cavity when the second pulley is in the second position.

3. The pulley assembly of claim 1, wherein the first pulley comprises a first axis of rotation and the second pulley comprises a second axis of rotation and wherein the first axis of rotation aligns with the second axis of rotation.

4. The pulley assembly of claim 1, wherein lateral alignment of the first pulley and the second pulley when the second pulley is in the second position comprises alignment of a center of a width of the first pulley with a center of a width of the second pulley.

5. The pulley assembly of claim 1, wherein the first pulley further comprises an axially extending collar, and wherein the second pulley is slideable along the axially extending collar.

6. The pulley assembly of claim 1, wherein the first pulley and the second pulley are rotatably coupled such that the first pulley and the second pulley rotate together.

7. The pulley assembly of claim 1, wherein the first pulley and the second pulley are coupled with one of a splined connection or a keyed connection that provides for relative axial sliding movement between the first pulley and the second pulley while simultaneous providing for concurrent rotation of the first pulley and the second pulley.

8. The pulley assembly of claim 1, wherein the first pulley defines a first drive component engaging surface configured to engage an endless component and wherein the second pulley defines a second drive component engaging surface configured to engage the endless component.

9. The pulley assembly of claim 8, wherein the first drive component engaging surface and the second drive component engaging surface are configured to engage an endless belt or an endless chain.

10. The pulley assembly of claim 8, wherein the first drive component engaging surface and the second drive component engaging surface are configured to conform to a V-belt.

11. The pulley assembly of claim 8, wherein the first drive component engaging surface and the second drive component engaging surface define a plurality of grooves.

12. The pulley assembly of claim 8, further comprising a locking arrangement that couples the first pulley to the second pulley so that the first pulley and the second pulley rotate together while preventing axial movement of the first pulley relative to the second pulley.

13. The pulley assembly of claim 12, wherein the locking arrangement comprises a pin removably received into aligned apertures formed in the first pulley and the second pulley to releasably coupled the first pulley and the second pulley together.

14. A drive system comprising:
a pulley assembly comprising:
first pulley comprising a first axis of rotation; and
a second pulley comprising a second axis of rotation that is aligned with the first axis of rotation, the second pulley slidable relative to the first pulley between a first position in which the second pulley is laterally offset from the first pulley and a second deposition in which the second pulley is laterally aligned with the first pulley;
a third pulley offset from the pulley assembly; and
an endless drive component engaged with the pulley assembly and the third pulley such that rotation of the pulley assembly or the third pulley is transmitted to the other of the pulley assembly and the third pulley via the endless drive component.

15. The drive system of claim 14, wherein the second pulley defines a cavity and wherein the first pulley is disposed in the cavity when the second pulley is in the second position.

16. The drive system of claim 14, wherein the endless drive component defines a centerline, and wherein a position of the centerline is maintained whether the endless drive component is engaged with either the first pulley or the second pulley.

17. The drive system of claim 14, wherein the first pulley aligns with the third pulley and wherein the second pulley aligns with the third pulley when the second pulley is in the second position.

18. The drive system of claim 14, wherein lateral alignment of the first pulley and the second pulley when the second pulley is in the second position comprises alignment of a center of a width of the first pulley with a center of a width of the second pulley.

19. The drive system of claim 14, wherein the pulley assembly further comprises a locking arrangement that couples the first pulley to the second pulley so that the first pulley and the second pulley rotate together while preventing axial movement of the first pulley relative to the second pulley.

20. The drive system of claim 19, wherein the locking arrangement comprises a pin removably received into aligned apertures formed in the first pulley and the second pulley to releasably coupled the first pulley and the second pulley together.
